(19) United States
(12) Patent Application Publication
(10) Pub. No.: US 2010/0183883 A1
(43) Pub. Date: Jul. 22, 2010

(54) WATER-DISPERSIBLE POLYISOCYANATES

(75) Inventors: Harald Schaefer, Mannheim (DE); Thomas Zech, Bobenheim-Roxheim (DE); Arno Duenkel, Meckesheim (DE); Nicolas Wiemer, Lambsheim (DE); Peter Keller, Spiesen-Elversberg (DE); Angelika Maria Steinbrecher, Stuttgart (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/669,221

(22) PCT Filed: Jul. 11, 2008
(86) PCT No.: PCT/EP08/59103

§ 371 Date: Jan. 15, 2010

(30) Foreign Application Priority Data
Jul. 19, 2007 (EP) 07112768.2

(51) Int. Cl. B32B 27/40; C08G 18/48; C09D 175/04

(52) U.S. Cl. 428/423.1; 528/85; 528/73; 524/539; 524/500

(57) ABSTRACT

The present invention relates to improved water-dispersible polyisocyanates intended more particularly for two-component polyurethane coating materials.

The present invention relates to improved water-dispersible polyisocyanates intended more particularly for two-component polyurethane coating materials or aqueous dispersion-based adhesives.

Water-dispersible polyisocyanates have already been known for a long time and are frequently used as a crosslinker component together with aqueous polyol solutions in aqueous coating systems. A large number of constituents with a water-dispersing effect have become established for such polyisocyanates.

DE 4113160 A1 describes water-dispersible polyisocyanates which contain not only polyether groups but also carboxylate groups.

Polyisocyanates containing such carboxylate groups as actively dispersing groups, however, exhibit inadequate stability on storage and an insufficient dispersibility.

EP 198343 A2, for instance, describes polyisocyanates which contain carbodiimide groups and which are rendered water-dispersible by means of sulfonate groups and, if appropriate, polyether groups. Disclosed explicitly as synthesis components carrying sulfonate groups are alkoxylated sulfonates, and sulfonated diisocyanates, which have to be prepared specially.

Moreover, EP 198343 A2 refers to N-(ω-aminoalkyl)-ω′-aminoalkylsulfonates in accordance with CA 928323 A1 as synthesis components which carry sulfonate groups.

EP 703255 A1 likewise describes water-dispersible polyisocyanates containing sulfonate groups. Hydroxyalkylsulfonates are disclosed explicitly for the purpose of improving the water-dispersibility, but not polyethers.

WO 2004/101638 (=US 2006/211815) describes self-emulsifying polyurethane dispersions which carry polyethylene oxide chains and may carry further ionic, actively dispersing groups.

EP 1287052 B1 discloses polyisocyanates which have been given a water-dispersible embodiment using 2-(cyclohexylamino)ethanesulfonic acid or 3-(cyclo-hexylamino)propanesulfonic acid. Optionally there may be polyether groups present as synthesis components.

Water-dispersible polyisocyanates of this kind display an unsatisfactory drying time.

EP 1704928 A2 describes aqueous coating compositions which in addition to a polyisocyanate crosslinker and a binder further comprise synthesis components which have a water-dispersibility effect after incorporation, and whose reactive group may be selected from the group consisting of primary and secondary amino groups, and whose groups with a dispersing action may be selected from the group consisting of sulfonic acid groups and phosphonic acid groups.

Examples given are a large number of aliphatic and aromatic sulfonic and phosphonic acids containing one or more isocyanate-reactive groups.

The compounds listed, however, exhibit inadequate dispersibility and drying (see comparative examples).

It was an object of the present invention to provide water-dispersible polyisocyanates which feature not only high ease of incorporation but also good drying properties.

This object has been achieved by means of water-dispersible polyisocyanates (A), comprising as synthesis components

(a) at least one diisocyanate or polyisocyanate,
(b) at least one substituted aromatic sulfonic acid which carries precisely one primary or secondary, preferably primary, amino group, the positions on the aromatic ring ortho to the amino group being unsubstituted,
(c) at least one monofunctional polyalkylene glycol,
(d) optionally at least one high molecular mass diol or polyol, and
(e) optionally at least one low molecular mass diol or polyol.

Such polyisocyanates (A) of the invention feature not only high ease of incorporation into aqueous polyol solutions but also good drying properties. Moreover, they give coatings featuring good hardness, which is manifested, for example, in high gloss.

Synthesis component (a) is at least one, one to three for example, one to two for preference, and more preferably precisely one diisocyanate or polyisocyanate.

The monomeric isocyanates used may be aromatic, aliphatic or cycloaliphatic, preferably aliphatic or cycloaliphatic, which is referred to for short in this text as (cyclo)aliphatic. Aliphatic isocyanates are particularly preferred.

Aromatic isocyanates are those which comprise at least one aromatic ring system, in other words not only purely aromatic compounds but also araliphatic compounds.

Cycloaliphatic isocyanates are those which comprise at least one cycloaliphatic ring system.

Aliphatic isocyanates are those which comprise exclusively linear or branched chains, i.e., acyclic compounds.

The monomeric isocyanates are preferably diisocyanates, which carry precisely two isocyanate groups. They can, however, in principle also be monoisocyanates having an isocyanate group.

In principle, higher isocyanates having on average more than 2 isocyanate groups are also possible. Suitability is possessed for example by triisocyanates, such as triisocyanatononane, 2,6-diisocyanato-1-hexanoic acid 2′-isocyanatoethyl ester, 2,4,6-triisocyanatotoluene, triphenylmethane triisocyanate or 2,4,4′-triisocyanatodiphenyl ether, or the mixtures of diisocyanates, triisocyanates, and higher polyisocyanates that are obtained, for example, by phosgenation of corresponding aniline/formaldehyde condensates and represent methylene-bridged polyphenyl polyisocyanates and the corresponding ring-hydrogenated isocyanates.

These monomeric isocyanates do not contain any substantial products of reaction of the isocyanate groups with themselves.

The monomeric isocyanates are preferably isocyanates having 4 to 20 carbon atoms. Examples of typical diisocyanates are aliphatic diisocyanates such as tetramethylene diisocyanate, pentamethylene 1,5-diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate (e.g. lysine methyl ester diisocyanate, lysine ethyl ester diisocyanate), trimethylhexane diisocyanate or tetramethylhexane diisocyanate, cycloaliphatic diisocyanates such as 1,4-, 1,3- or 1,2-diisocyanatocyclohexane, 4,4′- or 2,4′-di-(isocyanatocyclohexyl)methane, 1-isocyanato-3,3,5-trimethyl-5-(isocyanatomethyl)-cyclohexane (isophorone diisocyanate), 1,3- or 1,4-bis(isocyanatomethyl)cyclohexane or 2,4-, or 2,6-diisocyanato-1-methylcyclohexane, and also 3 (or 4), 8 (or 9)-bis-(isocyanatomethyl)tricyclo[5.2.1.0^{2,6}]decane isomer mixtures, and also aromatic diisocyanates such as tolylene 2,4- or 2,6-diisocyanate and the isomer mixtures thereof, m- or p-xylylene diisocyanate, 2,4′- or 4,4′-diisocyanatodiphenylmethane and the isomer mixtures thereof, phenylene 1,3- or 1,4-diisocyanate, 1-chlorophenylene 2,4-diisocyanate, naphthylene 1,5-diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate.

Particular preference is given to hexamethylene 1,6-diisocyanate, 1,3-bis(isocyanato-methyl)cyclohexane, isophorone diisocyanate, and 4,4′- or 2,4′-di(isocyanato-cyclohexyl)methane, very particular preference to isophorone diisocyanate and hexamethylene 1,6-diisocyanate, and especial preference to hexamethylene 1,6-diisocyanate.

Mixtures of said isocyanates may also be present.

Isophorone diisocyanate is usually in the form of a mixture, specifically a mixture of the cis and trans isomers, generally in a proportion of about 60:40 to 80:20 (w/w), preferably in a proportion of about 70:30 to 75:25, and more preferably in a proportion of approximately 75:25.

Dicyclohexylmethane 4,4′-diisocyanate may likewise be in the form of a mixture of the different cis and trans isomers.

For the present invention it is possible to use not only those diisocyanates obtained by phosgenating the corresponding amines but also those prepared without the use of phosgene, i.e., by phosgene-free processes. According to EP-A-0 126 299 (U.S. Pat. No. 4,596,678), EP-A-126 300 (U.S. Pat. No. 4,596,679), and EP-A-355 443 (U.S. Pat. No. 5,087,739), for example, (cyclo)aliphatic diisocyanates, such as hexamethylene 1,6-diisocyanate (HDI), isomeric aliphatic diisocyanates having 6 carbon atoms in the alkylene radical, 4,4′- or 2,4′-di(isocyanatocyclohexyl)methane, and 1-isocyanato-3-isocyanatomethyl-3,5,5-trimethylcyclohexane (isophorone diisocyanate or IPDI), for example, can be prepared by reacting the (cyclo)aliphatic diamines with, for example, urea and alcohols to give (cyclo)aliphatic biscarbamic esters and subjecting said esters to thermal cleavage into the corresponding diisocyanates and alcohols. The synthesis takes place usually continuously in a circulation process and in the presence, if appropriate, of N-unsubstituted carbamic esters, dialkyl carbonates, and other by-products recycled from the reaction process. Diisocyanates obtained in this way generally contain a very low or even unmeasurable fraction of chlorinated compounds, which is advantageous, for example, in applications in the electronics industry.

In one embodiment of the present invention the isocyanates used have a total hydrolyzable chlorine content of less than 200 ppm, preferably of less than 120 ppm, more preferably less than 80 ppm, very preferably less than 50 ppm, in particular less than 15 ppm, and especially less than 10 ppm. This can be measured by means, for example, of ASTM specification D4663-98. Of course, though, monomeric isocyanates having a higher chlorine content can also be used, of up to 500 ppm, for example.

It will be appreciated that it is also possible to employ mixtures of those monomeric isocyanates which have been obtained by reacting the (cyclo)aliphatic diamines with, for example, urea and alcohols and cleaving the resulting (cyclo)aliphatic biscarbaminic esters, with those diisocyanates which have been obtained by phosgenating the corresponding amines.

The polyisocyanates (a) to which the monomeric isocyanates can be oligomerized are generally characterized as follows:

The average NCO functionality of such compounds is in general at least 1.8 and can be up to 8, preferably 2 to 5, and more preferably 2.4 to 4.

The isocyanate group content after oligomerization, calculated as NCO=42 g/mol, is generally from 5% to 25% by weight unless otherwise specified.

The polyisocyanates (a) are preferably compounds as follows:
1) Polyisocyanates containing isocyanurate groups and derived from aromatic, aliphatic and/or cycloaliphatic diisocyanates. Particular preference is given in this context to the corresponding aliphatic and/or cycloaliphatic isocyanatoiso-cyanurates and in particular to those based on hexamethylene diisocyanate and isophorone diisocyanate. The isocyanurates present are, in particular, tris-isocyanatoalkyl and/or trisisocyanatocycloalkyl isocyanurates, which constitute cyclic trimers of the diisocyanates, or are mixtures with their higher homologs containing more than one isocyanurate ring. The isocyanatoisocyanurates generally have an NCO content of 10% to 30% by weight, in particular 15% to 25% by weight, and an average NCO functionality of 2.6 to 8.
2) Polyisocyanates containing uretdione groups and having aromatically, aliphatically and/or cycloaliphatically attached isocyanate groups, preferably aliphatically and/or cycloaliphatically attached, and in particular those derived from hexamethylene diisocyanate or isophorone diisocyanate. Uretdione diisocyanates are cyclic dimerization products of diisocyanates.
   The polyisocyanates containing uretdione groups are obtained in the context of this invention as a mixture with other polyisocyanates, more particularly those specified under 1). For this purpose the diisocyanates can be reacted under reaction conditions under which not only uretdione groups but also the other polyisocyanates are formed, or the uretdione groups are formed first of all and are subsequently reacted to give the other polyisocyanates, or the diisocyanates are first reacted to give the other polyisocyanates, which are subsequently reacted to give products containing uretdione groups.
3) Polyisocyanates containing biuret groups and having aromatically, cyclo-aliphatically or aliphatically attached, preferably cycloaliphatically or aliphatically attached, isocyanate groups, especially tris(6-isocyanatohexyl)biuret or its mixtures with its higher homologs. These polyisocyanates containing biuret groups generally have an NCO content of 18% to 22% by weight and an average NCO functionality of 2.8 to 6.
4) Polyisocyanates containing urethane and/or allophanate groups and having aromatically, aliphatically or cycloaliphatically attached, preferably aliphatically or cycloaliphatically attached, isocyanate groups, such as may be obtained, for example, by reacting excess amounts of diisocyanate, such as of hexamethylene diisocyanate or of isophorone diisocyanate, with mono- or polyhydric alcohols (a). These polyisocyanates containing urethane and/or allophanate groups generally have an NCO content of 12% to 24% by weight and an average NCO functionality of 2.1 to 4.5. Polyisocyanates of this kind containing urethane and/or allophanate groups may be prepared without catalyst or, preferably, in the presence of catalysts, such as ammonium carboxylates or ammonium hydroxides, for example, or allophanatization catalysts, such as Zn(II) compounds, for example, in each case in the presence of monohydric, dihydric or polyhydric, preferably monohydric, alcohols. The polyisocyanates containing urethane and/or allophanate groups can also be prepared in a mixture with other polyisocyanates, more particularly those specified under 1).
5) Polyisocyanates comprising oxadiazinetrione groups, derived preferably from hexamethylene diisocyanate or isophorone diisocyanate. Polyisocyanates of this kind comprising oxadiazinetrione groups are accessible from diisocyanate and carbon dioxide.
6) Polyisocyanates comprising iminooxadiazinedione groups, derived preferably from hexamethylene diisocyanate or isophorone diisocyanate. Polyisocyanates of this kind comprising iminooxadiazinedione groups are preparable from diisocyanates by means of specific catalysts.
7) Uretonimine-modified polyisocyanates.
8) Carbodiimide-modified polyisocyanates.
9) Hyperbranched polyisocyanates, of the kind known for example from DE-A1 10013186 or DE-A1 10013187.
10) Polyurethane-polyisocyanate prepolymers, from di- and/or polyisocyanates with alcohols.
11) Polyurea-polyisocyanate prepolymers.
12) The polyisocyanates 1)-11), preferably 1), 3), 4) and 6), can be converted, following their preparation, into polyisocyanates containing biuret groups or urethane/allophanate groups and having aromatically, cycloaliphatically or aliphatically attached, preferably (cyclo)aliphatically attached, isocyanate groups. The formation of biuret groups, for example, is accomplished by addition of water, water donor compounds (e.g., tert-butanol), or by reaction with amines. The formation of urethane and/or allophanate groups is accomplished by reaction with monohydric, dihydric or polyhydric, preferably monohydric, alcohols, in the presence if appropriate of suitable catalysts. These polyisocyanates containing biuret or urethane/allophanate groups generally have an NCO content of 18% to 22% by weight and an average NCO functionality of 2.8 to 6.
13) Hydrophilically modified polyisocyanates, i.e., polyisocyanates which as well as the groups described under 1-12 also comprise groups which result formally from addition of molecules containing NCO-reactive groups and hydrophilizing groups to the isocyanate groups of above molecules. The latter groups are nonionic groups such as alkylpolyethylene oxide and/or ionic groups derived from phosphoric acid, phosphonic acid, sulfuric acid or sulfonic acid, and/or their salts.
14) Modified polyisocyanates for dual care applications, i.e., polyisocyanates which as well as the groups described under 1-12 also comprise groups resulting formally from addition of molecules containing NCO-reactive groups and UV-crosslinkable or actinic-radiation-crosslinkable groups to the isocyanate groups of above molecules. These molecules are, for example, hydroxyalkyl (meth)acrylates and other hydroxyl-vinyl compounds.

The diisocyanates or polyisocyanates recited above may also be present at least partly in blocked form.

Classes of compounds used for blocking are described in D. A. Wicks, Z. W. Wicks, Progress in Organic Coatings, 36, 148-172 (1999), 41, 1-83 (2001) and also 43, 131-140 (2001).

Examples of classes of compounds used for blocking are phenols, imidazoles, triazoles, pyrazoles, oximes, N-hydroxyimides, hydroxylbenzoic esters, secondary amines, lactams, CH-acidic cyclic ketones, malonic esters or alkyl acetoacetates.

In one preferred embodiment of the present invention the polyisocyanate (a) is selected from the group consisting of isocyanurates, biurets, urethanes and allophanates, preferably from the group consisting of isocyanurates, urethanes and allophanates, more preferably from the group consisting of isocyanurates and allophanates; in particular it is a polyisocyanate containing isocyanurate groups.

In one particularly preferred embodiment the polyisocyanate (a) encompasses polyisocyanates comprising isocyanurate groups and obtained from hexamethylene 1,6-diisocyanate.

In one further particularly preferred embodiment the polyisocyanate (a) encompasses a mixture of polyisocyanates comprising isocyanurate groups and obtained from hexamethylene 1,6-diisocyanate and from isophorone diisocyanate.

In one particularly preferred embodiment the polyisocyanate (a) encompasses a mixture comprising low-viscosity polyisocyanates, preferably polyisocyanates comprising isocyanurate groups, having a viscosity of 600-1500 mPa*s, more particularly below 1200 mPa*s, low-viscosity urethanes and/or allophanates having a viscosity of 200-1600 mPa*s, more particularly 600-1500 mPa*s, and/or polyisocyanates comprising iminooxadiazinedione groups.

In this specification the viscosity at 23° C. in accordance with DIN EN ISO 3219/A.3 is specified, in a cone/plate system at a shear rate of 250 s⁻¹, unless noted otherwise.

Synthesis component (b) is at least one, one to three for example, one to two for preference, and more preferably precisely one substituted aromatic sulfonic acid which carries precisely one primary or secondary, preferably primary, amino group, the positions on the aromatic ring ortho to the amino group being unsubstituted.

These synthesis components (b) may carry at least one, one to three for example, one to two for preference, and more preferably precisely one sulfonic acid group.

Preferred such substituted aromatic sulfonic acids are those of the formula (I)

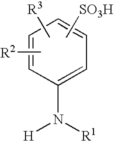

in which
R¹, R² and R³ independently of one another are hydrogen, alkyl, cycloalkyl or aryl, it being possible for each of the stated radicals to be substituted by aryl, alkyl, aryloxy, alkyloxy, heteroatoms and/or heterocycles,
and R² and R³ may also together form a ring, preferably a fused-on aromatic ring, with the proviso that at least one of the radicals R² and R³ is other than hydrogen.

Definitions therein are as follows:

C₁-C₁₈ alkyl substituted if appropriate by aryl, alkyl, aryloxy, alkyloxy, heteroatoms and/or heterocycles is for example methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hexadecyl, octadecyl, 1,1-dimethylpropyl, 1,1-dimethylbutyl, 1,1,3,3-tetra-methylbutyl, benzyl, 1-phenylethyl, 2-phenylethyl, α,α-dimethylbenzyl, benzhydryl, p-tolylmethy-1,1-(p-butylphenyl)ethyl, p-chlorobenzyl, 2,4-dichlorobenzyl, p-methoxy-benzyl, m-ethoxybenzyl, 2-cyanoethyl, 2-cyanopropyl, 2-methoxycarbonethyl, 2-ethoxy-carbonylethyl, 2-butoxycarbonylpropyl, 1,2-di(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, 2-chloroethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl,

C₆-C₁₂ aryl substituted if appropriate by aryl, alkyl, aryloxy, alkyloxy, heteroatoms and/or heterocycles is for example phenyl, tolyl, xylyl, α-naphthyl, β-naphthyl, 4-biphenylyl, chlorophenyl, dichlorophenyl, trichlorophenyl, difluorophenyl, methylphenyl, dimethylphenyl, trimethylphenyl, ethylphenyl, diethylphenyl, iso-propyl-phenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl, and

C₅-C₁₂ cycloalkyl substituted if appropriate by aryl, alkyl, aryloxy, alkyloxy, heteroatoms and/or heterocycles is for example cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, and a saturated or unsaturated bicyclic system such as norbornyl or norbornenyl, for example.

Preferably R¹ can be hydrogen, unsubstituted alkyl or unsubstituted cycloalkyl, more preferably hydrogen, methyl, ethyl, n-propyl, isopropyl, tert-butyl, cyclopentyl, and cyclohexyl, very preferably hydrogen and methyl, and more particularly hydrogen.

Preferably R² and R³ independently of one another can be hydrogen, unsubstituted alkyl or unsubstituted aryl, more preferably hydrogen, methyl, ethyl, isopropyl, tert-butyl, hexyl, octyl, nonyl, decyl, dodecyl, phenyl or naphthyl, very preferably hydrogen, methyl, ethyl, isopropyl or phenyl, and more particularly hydrogen and methyl. Where R² and R³ together form a ring, then R² and R³ may form a butyl-1,4-ylene chain or, preferably, a 1,3-butadien-1,4-ylene chain, so forming a tetrahydronaphthalene or naphthalene ring, respectively, as the aromatic ring.

Preferably one of the radicals R² and R³ is hydrogen and the other is other than hydrogen.

The sulfonic acid group is located para or meta relative to the primary or secondary amino group on the aromatic ring, preferably meta.

The substituents R² and R³ are likewise located para or meta relative to the primary or secondary amino group on the aromatic ring, depending on the position of the sulfonic acid group. For the preferred case where one of the radicals R² and R³ is hydrogen and the other is other than hydrogen, the radical which is other than hydrogen is preferably located para on the aromatic ring relative to the primary or secondary amino group.

It is therefore a preferred embodiment of the invention for the sulfonic acid group to be located in position 4 relative to the primary or secondary amino group on the aromatic ring, and for the radical of R² and R³ that is other than hydrogen to be located in position 3 relative to the primary or secondary amino group.

It is a further preferred embodiment of the invention for the sulfonic acid group to be located in position 3 relative to the primary or secondary amino group on the aromatic ring, and for the radical of R² and R³ that is other than hydrogen to be located in position 5 relative to the primary or secondary amino group.

It is a particularly preferred embodiment of the invention for the sulfonic acid group to be located in position 3 relative to the primary or secondary amino group on the aromatic ring, and for the radical of R² and R³ that is other than hydrogen to be located in position 4 relative to the primary or secondary amino group.

In accordance with the invention the two ortho positions on either side of the primary or secondary amino group on the aromatic ring are unsubstituted.

The compounds (b) are preferably 4-aminotoluene-2-sulfonic acid, 5-aminotoluene-2-sulfonic acid or 2-aminonaphthalene-4-sulfonic acid, more preferably 4-aminotoluene-2-sulfonic acid.

Component (c) encompasses monofunctional polyalkylene oxide polyether alcohols, which are reaction products of suitable starter molecules with polyalkylene oxides.

Suitable starter molecules for preparing monohydric polyalkylene oxide polyether alcohols are thiol compounds, monohydroxy compounds of the general formula

R⁴—O—H

or secondary monoamines of the general formula

R⁵R⁶N—H,

in which
R⁴, R⁵ and R⁶ each independently of one another are C₁-C₂₀ alkyl, C₂-C₂₀ alkyl uninterrupted or interrupted by one or more oxygen and/or sulfur atoms and/or by one or more substituted or unsubstituted imino groups, or C₆-C₁₂ aryl, C₅-C₁₂ cycloalkyl or a five- to six-membered heterocycle containing oxygen, nitrogen and/or sulfur atoms, or R⁵ and R⁶ together form an unsaturated, saturated or aromatic ring which is uninterrupted or interrupted by one or more oxygen and/or sulfur atoms and/or by one or more substituted or unsubstituted imino groups, it being possible for the stated radicals to be substituted in each case by functional groups, aryl, alkyl, aryloxy, alkyloxy, halogen, heteroatoms and/or heterocycles.

Preferably R⁴, R⁵, and R⁶ independently of one another are C₁- to C₄ alkyl, i.e., methyl, ethyl, isopropyl, n-propyl, n-butyl, isobutyl, sec-butyl or tert-butyl; more preferably R⁴, R⁵, and R⁶ are methyl.

Examples of suitable monovalent starter molecules are saturated monoalcohols such as methanol, ethanol, n-propanol, isopropanol, n-butanol, isobutanol, sec-butanol, the isomeric pentanols, hexanols, octanols, and nonanols, n-decanol, n-dodecanol, n-tetradecanol, n-hexadecanol, n-octadecanol, cyclohexanol, cyclopentanol, the isomeric methylcyclohexanols or hydroxymethylcyclohexane, 3-ethyl-3-hydroxy-methyloxetane, or tetrahydrofurfuryl alcohol; unsaturated alcohols such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinnamyl alcohol; secondary monoamines such as dimethylamine, diethylamine, dipropylamine, diisopropylamine, di-n-butylamine, diisobutylamine, bis(2-ethylhexyl)amine, N-methyl- and N-ethylcyclohexylamine or dicyclohexylamine, heterocyclic secondary amines such as morpholine, pyrrolidine, piperidine or 1H-pyrazole, and also amino alcohols such as 2-dimethylaminoethanol, 2-diethylaminoethanol, 2-diisopropylaminoethanol, 2-dibutylaminoethanol, 3-(dimethylamino)-1-propanol or 1-(dimethylamino)-2-propanol.

Examples of polyethers prepared starting from amines are the Jeffamine® M series, which represent methyl-capped polyalkylene oxides with an amino function, such as M-600 (XTJ-505), having a propylene oxide (PO)/ethylene oxide (EO) ratio of approximately 9:1 and a molar mass of approximately 600, M-1000 (XTJ-506): PO/EO ratio 3:19, molar mass approximately 1000, M-2005 (XTJ-507): PO/EO ratio 29:0, molar mass approximately 2000, or M-2070: PO/EO ratio 10:31, molar mass approximately 2000.

Alkylene oxides suitable for the alkoxylation reaction are ethylene oxide, propylene oxide, isobutylene oxide, vinyloxirane and/or styrene oxide, which may be used in any order or else in a mixture in the alkoxylation reaction.

Preferred alkylene oxides are ethylene oxide, propylene oxide, and their mixtures; ethylene oxide is particularly preferred.

Preferred polyether alcohols are those which are based on polyalkylene oxide polyether alcohols in whose preparation saturated aliphatic or cycloaliphatic alcohols of the abovementioned kind were used as starter molecules. Very particular preference is given to those based on polyalkylene oxide polyether alcohols prepared using saturated aliphatic alcohols having 1 to 4 carbon atoms in the alkyl radical. Particular preference is given to polyalkylene oxide polyether alcohols prepared starting from methanol.

The monohydric polyalkylene oxide polyether alcohols have on average in general at least two alkylene oxide units, preferably at least 5 alkylene oxide units, per molecule, more preferably at least 7, and very preferably at least 10 alkylene oxide units, more particularly ethylene oxides unit.

The monohydric polyalkylene oxide polyether alcohols have on average in general up to 50 alkylene oxide units per molecule, preferably up to 45, more preferably up to 40, and very preferably up to 30 alkylene oxide units, more particularly ethylene oxide units.

The molar weight of the monohydric polyalkylene oxide polyether alcohols is preferably up to 4000, more preferably not above 2000 g/mol, very preferably not below 250 and more particularly 500±100 g/mol.

Preferred polyether alcohols are therefore compounds of the formula

R⁴—O—[—Xᵢ—]ₖ—H

in which
R⁴ is as defined above,
k is an integer from 5 to 40, preferably 7 to 20, and more preferably 10 to 15, and each X for i=1 to k can be selected independently from the group consisting of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, and —CHPh-CH₂—O—, preferably from the group consisting of —CH₂—CH₂—O—, —CH₂—CH(CH₃)—O— and —CH(CH₃)—CH₂—O—, and more preferably —CH₂—CH₂—O—
in which Ph is phenyl and Vin is vinyl.

The polyalkylene oxide polyether alcohols are generally prepared by alkoxylating the starter compounds in the presence of a catalyst, such as of an alkali metal or alkaline earth metal hydroxide, oxide, carbonate or hydrogencarbonate, for example.

The polyalkylene oxide polyether alcohols can also be prepared with the aid of multimetal cyanide compounds, frequently also referred to as DMC catalysts, which have been known for a long time and have been widely described in the literature, as for example in U.S. Pat. No. 3,278,457 and in U.S. Pat. No. 5,783,513.

The DMC catalysts are typically prepared by reacting a metal salt with a cyanometalate compound. To enhance the properties of the DMC catalysts it is customary to add organic ligands during and/or after the reaction. A description of the preparation of DMC catalysts is found, for example, in U.S. Pat. No. 3,278,457.

Typical DMC catalysts have the following general formula:

M¹ₐ[M²(CN)_{b}]_{d}.fM¹ⱼXₖ.h(H₂O)eL.zP

in which
M¹ is a metal ion selected from the group comprising Zn²⁺, Fe²⁺, Fe³⁺, Co²⁺, Co³⁺, Ni²⁺, Mn²⁺, Sn²⁺, Sn⁴⁺, Pb²⁺, Al³⁺, Sr²⁺, Cr³⁺, Cd²⁺, Cu²⁺, La³⁺, Ce³⁺, Ce⁴⁺, Eu³⁺, Mg²⁺, Ti⁴⁺, Ag⁺, Rh²⁺, Ru²⁺, Ru³⁺, Pd²⁺,
M² is a metal ion selected from the group comprising Fe²⁺, Fe³⁺, Co²⁺, Co³⁺, Mn²⁺, Mn³⁺, Ni²⁺, Cr²⁺, Cr³⁺, Rh³⁺, Ru²⁺, Ir³⁺,
M¹ and M² are alike or different,
X is an anion selected from the group comprising halide, hydroxide, sulfate, hydrogen sulfate, carbonate, hydrogen carbonate, cyanide, thiocyanate, isocyanate, cyanate, carboxylate, oxalate, nitrate or nitrite (NO₂⁻) or a mixture of two or more of the aforementioned anions, or a mixture of one or more of the aforementioned anions with one of the uncharged species selected from CO, H₂O, and NO,
Y is an anion which is different than X and is selected from the group comprising halide, sulfate, hydrogen sulfate, disulfate, sulfite, sulfonate (═RSO₃⁻ with R═C1-C20 alkyl, aryl, C1-C20 alkylaryl), carbonate, hydrogen carbonate, cyanide, thiocyanate, isocyanate, isothiocyanate, cyanate, carboxylate, oxalate, nitrate, nitrite, phosphate, hydrogen phosphate, dihydrogen phosphate, diphosphate, borate, tetraborate, perchlorate, tetrafluoroborate, hexafluorophosphate, and tetraphenylborate,
L is a water-miscible ligand selected from the group comprising alcohols, aldehydes, ketones, ethers, polyethers, esters, polyesters, polycarbonate, ureas, amides, nitriles, and sulfides or mixtures thereof,
P is an organic additive selected from the group comprising polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylamide-co-maleic acid), polyacrylnitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymer, hydroxylethyl-cellulose, polyacetates, ionic surface- and interface-active compounds, bile acid or salts, esters or amides thereof, carboxylic esters of polyhydric alcohols, and glycosides,
and
a, b, d, g, n, r, s, j, k, and t are integral or fractional numbers greater than zero, e, f, h and z are integral or fractional numbers greater than or equal to zero,
with
a, b, d, g, n, j, k, and r, and also s and t, being selected so as to ensure electroneutrality,
M³ being hydrogen or an alkali metal or alkaline earth metal, and
M⁴ being alkali metal ions or an ammonium ion (NH₄⁺) or an alkylammonium ion (R₄N⁺, R₃NH⁺, R₂NH₂⁺, RNH₃⁺ with R═C1-C20 alkyl).

In one particularly preferred embodiment of the invention M¹ is Zn²⁺ and M² is Co³⁺ or Co²⁺.

The metals M¹ and M² are alike particularly when they are cobalt, manganese or iron.

The residues of the catalyst may remain in the product obtained or may be neutralized using an acid, preferably hydrochloric acid, sulfuric acid or acetic acid, with the salts being subsequently removable preferably by means, for example, of washing or of ion exchangers. If appropriate, a partial neutralization may take place, and the product may be used further without further removal of the salts.

The optional synthesis component (d) encompasses high molecular mass diols or polyols, by which is meant a number-average molecular weight of at least 400, preferably 400 to 6000.

The compounds in question are more particularly dihydric or polyhydric polyester polyols and polyether polyols, the dihydric polyols being preferred.

Suitable polyester polyols include, in particular, the conventional reaction products of polyhydric alcohols with polybasic carboxylic acids, with the alcoholic component being employed in excess. The polybasic carboxylic acids may be aliphatic, cycloaliphatic, aromatic, heterocyclic or ethylenically unsaturated in nature and may also, if appropriate, carry halogen atom substituents. Instead of the polybasic carboxylic acids it is also possible for their anhydrides to be esterified. Examples of suitable polybasic starting carboxylic acids include the following: succinic acid, adipic acid, sebacic acid, phthalic acid, isophthalic acid, trimellitic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride or fumaric acid.

Polyhydric alcohols for use in excess include the following: ethane-1,2-diol, propane-1,2-diol, propane-1,3-diol, butane-1,2-diol, butane-1,3-diol, butane-1,4-diol, butene-1,4-diol, butyne-1,4-diol, pentane-1,5-diol and its positional isomers, hexane-1,6-diol, octane-1,8-diol, 1,4-bishydroxymethylcyclohexane, 2,2-bis4-hydroxycyclohexyl)propane, 2-methyl-1,3-propanediol, glycerol, trimethylolpropane, trimethylolethane, hexane-1,2,6-triol, butane-1,2,4-triol, diethylene glycol, triethylene glycol, tetraethylene glycol, polyethylene glycol having a molar mass of 378 to 900, preferably of 378 to 678, poly-1,2-propylene glycol or poly-1,3-propanediol with a molar mass of 134 to 1178, preferably 134 to 888, poly THF having a molar mass of 162 to 2000, preferably between 378 and 1458, with particular preference 378 to 678.

Preference is given to polyester polyols formed from diols and dicarboxylic acids.

Further suitable polyester polyols are the adducts of lactones or lactone mixtures with dihydric alcohols used as starter molecules. Examples of preferred lactones are ε-caprolactone, β-propiolactone, γ-butyrolactone or methyl-ε-caprolactone.

Suitable starter molecules are more particularly the low molecular mass dihydric alcohols already specified as synthesis components for the polyester polyols.

Also suitable, of course, are polyesters formed from hydroxycarboxylic acids as synthesis components. Synthesis components (d) suitable as polyesters are, furthermore, also polycarbonates, of the kind obtainable, for example, from phosgene or diphenyl carbonate and, in excess, the low molecular mass dihydric alcohols specified as synthesis components for the polyester polyols.

Suitable synthesis components (d) with polyether polyol suitability include, preferably, polyether diols, of the kind obtainable, for example, by boron trifluoride-catalyzed linking of ethylene oxide, propylene oxide, butylene oxide, tetrahydrofuran, styrene oxide or epichlorohydrin to itself or to one another, or by addition reaction of these compounds, individually or in a mixture, with starter components containing reactive hydrogen atoms, such as water, polyfunctional alcohols or amines such as ethane-1,2-diol, propane-1,3-diol, 1,2- or 2,2-bis(4-hydroxyphenyl)propane, or aniline. Furthermore, polyether-1,3-diols, examples being trimethylolpropane which is alkoxylated on one OH group and whose alkylene oxide chain is capped with an alkyl radical comprising 1 to 18 C atoms, are synthesis components (d) employed with preference.

Optional synthesis components (e) may be low molecular mass dihydric or polyhydric alcohols, among which the dihydric alcohols are preferred. Low molecular mass here denotes a number-average molecular weight from 62 to 399.

Suitable synthesis components (e) include ethane-1,2-diol, propane-1,2-diol, propane-1,3-diol, butane-1,2-diol, butane-1,3-diol, butane-1,4-diol, butene-1,4-diol, butyne-1,4-diol, pentane-1,5-diol and its positional isomers, hexane-1,6-diol, octane-1,8-diol, 1,4-bishydroxymethylcyclohexane, 2,2-bis(4-hydroxycyclohexyl)propane, 2-methyl-1,3-propanediol, glycerol, trimethylolpropane, trimethylolethane, hexane-1,2,6-triol, butane-1,2,4-triol, diethylene glycol, triethylene glycol, tetraethylene glycol, low molecular mass polyethylene glycol, poly-1,2-propylene glycol, poly-1,3-propanediol or poly THF, and also polyhydric alcohols such as trimethylolbutane, trimethylolpropane, trimethylolethane, neopentyl glycol, neopentyl glycol hydroxypivalate, pentaerythritol, 2-ethyl-1,3-propanediol, 2-methyl-1,3-propanediol, 2-ethyl-1,3-hexanediol, glycerol, ditrimethylolpropane, dipentaerythritol, hydroquinone, bisphenol A, bisphenol F, bisphenol B, bisphenol S, 2,2-bis(4-hydroxy-cyclohexyl)propane, 1,1-, 1,2-, 1,3-, and 1,4-cyclohexanedimethanol, 1,2-, 1,3- or 1,4-cyclohexanediol or sugar alcohols such as sorbitol, mannitol, diglycerol, threitol, erythritol, adonitol (ribitol), arabitol (lyxitol), xylitol, dulcitol (galactitol), maltitol or isomalt. Preference is given to using linear 1,ω-dihydroxyalkanes, more preferably butane-1,4-diol and hexane-1,6-diol.

The polyisocyanates (A) generally have the following construction, based on isocyanate groups (calculated as NCO with a molecular weight of 42 g/mol) in synthesis component (a):

(b) 0.5 to 30 mol % of primary or secondary amino groups, preferably 0.8 to 25 mol % and more preferably 1.0 to 20 mol %,
(c) at least 0.3 mol %, preferably at least 0.5, more preferably at least 1.0, and very preferably at least 1.2 mol %, and also up to 25 mol %, preferably up to 20, more preferably up to 15, and very preferably up to 10 mol %, based on isocyanate-reactive groups in (c),
(d) 0 to 15 mol %, preferably 0 to 10 mol %, more preferably 0 to 5 mol %, and very preferably 0 mol %, based on isocyanate-reactive groups in (d), and
(e) 0 to 15 mol %, preferably 0 to 10 mol %, more preferably 0 to 5 mol %, and very preferably 0 mol %, based on isocyanate-reactive groups in (e).

The NCO content of the polyisocyanates (A) of the invention is generally 13% by weight or more, preferably 14% by weight or more, more preferably 15% by weight or more, and very preferably 16% by weight or more, in conjunction with very good water-dispersibility. Normally 22% by weight is not exceeded.

The amount of sulfonate groups incorporated into the polyisocyanate (A) (and calculated as SO₃H of a M_{w} of 81.07 g/mol, measured potentiometrically as the acid number in accordance with DIN 53402) is at least 1, preferably at least 1.5, more preferably at least 2, and very preferably at least 2.5 mg KOH/g, and can be up to 200, preferably up to 180, more preferably up to 150, and very preferably up to 130 mg KOH/g.

Preferred polyisocyanates (A) have a fraction of the structural units —[—CH₂—CH₂—O—]—, calculated as 44 g/mol, in relation to the sum of components a)+b)+c)+d)+e), of at least 1%, preferably at least 1.5%, and more preferably at least 2%, by weight. In general the fraction is not more than 20%, preferably not more than 12%, and more preferably not more than 10% by weight.

The number-average molar weight Mₙ (determined by gel permeation chromatography using THF as solvent and polystyrene as standard) of the polyisocyanates of the invention is generally at least 400, preferably at least 500, more preferably at least 700, and very preferably at least 1000, and is up to 5000, preferably up to 3000, more preferably up to 2000, and very preferably up to 1500.

In general the viscosity of the water-emulsifiable polyisocyanates of the invention is below 10 000 mPa*s, preferably below 9000 mPa*s, more preferably below 8000 mPa*s, very preferably below 7000 mPa*s, and more particularly between 800 and 6000 mPa*s, so that dilution with solvent is unnecessary.

The polyisocyanates (A) of the invention are frequently at least partly neutralized with at least one base (B).

The bases in question may be basic alkali metal, alkaline earth metal or ammonium salts, more particularly the sodium, potassium, cesium, magnesium, calcium and barium salts, especially sodium, potassium, and calcium salts, in the form of hydroxides, oxides, hydrogen carbonates or carbonates, preferably in the form of the hydroxides.

Preferred compounds (B), however, are ammonia or amines, preferably tertiary amines. The tertiary amines in question are preferably those which are exclusively alkyl-substituted and/or cycloalkyl-substituted.

Examples of such amines are trimethylamine, triethylamine, tri-n-butylamine, ethyl-diisopropylamine, dimethylbenzylamine, dimethylphenylamine, triethanolamine, cyclopentyldimethylamine, cyclopentyldiethylamine, cyclohexyldimethylamine, and cyclohexyldiethylamine.

Conceivable, though less preferred, are also heterocyclic amines, however, such as pyridine, imidazole, N-alkylated morpholine, piperidine, piperazine or pyrrolidone.

Generally speaking, the base (B) is used to neutralize 10 to 100 mol % of the acid groups present in (A), preferably 20 to 100 mol %, more preferably 40 to 100 mol %, very preferably 50 to 100 mol %, and more particularly 70 to 100 mol %.

The at least partial neutralization of component (b) in the polyisocyanate (A) can take place before, during or after the preparation of the polyisocyanate (A).

The polyisocyanates (A) are generally prepared by mixing and reacting the synthesis components in any order. Preference is given to introducing the diisocyanate or polyisocyanate (a) initially, adding the synthesis components (b) and/or (c) together or in succession, and allowing reaction to take place until the reactive groups in (b) and (c) have been converted. Subsequently, if desired, the compounds (d) and/or (e) can be added.

Also conceivable is a reaction regime in which monomeric diisocyanates are reacted with one another as components (a) in the presence of the compounds (b) and/or (c). A reaction regime of this kind is described in the unpublished European patent application with the file reference 07104873.0 and the filing date of Mar. 26, 2007, hereby fully incorporated by reference as part of the present disclosure content.

The reaction is carried out in general at a temperature of between 40° C. and 170° C., preferably between 45° C. and 160° C., more preferably between 50 and 150° C., and very preferably between 60 and 140° C.

The reaction can be accelerated by adding the typical catalysts (C) which catalyze the reaction of isocyanate groups with isocyanate-reactive groups. Suitable for this purpose in principle are all of the catalysts that are typically used in polyurethane chemistry.

These catalysts are, for example, organic amines, more particularly tertiary aliphatic, cycloaliphatic or aromatic amines, and/or Lewis-acidic organometallic compounds. Examples of suitable Lewis-acidic organometallic compounds include tin compounds, such as tin(II) salts of organic carboxylic acids, for example, such as tin(II) acetate, tin(II) octoate, tin(II) ethylhexoate, and tin(II) laurate, for example, and the dialkyltin(IV) salts of organic carboxylic acids, examples being dimethyltin diacetate, dibutyltin diacetate, dibutyltin dibutyrate, dibutyltin bis(2-ethylhexanoate), dibutyltin dilaurate, dibutyltin maleate, dioctyltin dilaurate, and dioctyltin diacetate. Also possible are metal complexes such as acetylacetonates of iron, of titanium, of aluminum, of zirconium, of manganese, of nickel, and of cobalt. Further metal catalysts are described by Blank et al. in Progress in Organic Coatings, 1999, vol. 35, pages 19-29.

Preferred Lewis-acidic organometallic compounds are dimethyltin diacetate, dibutyltin dibutyrate, dibutyltin bis(2-ethylhexanoate), dibutyltin dilaurate, dioctyltin dilaurate, zirconium acetylacetonate, and zirconium 2,2,6,6-tetramethyl-3,5-heptanedionate.

Additionally, bismuth catalysts and cobalt catalysts, and cesium salts too, can be used as catalysts. Suitable cesium salts are those compounds in which the following anions are used: F⁻, Cl⁻, ClO⁻, ClO₃⁻, ClO₄⁻, Br⁻, I⁻, IO₃⁻, CN⁻, OCN⁻, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, H₂PO₂⁻, H₂PO₄⁻, HPO₄²⁻, PO₄³⁻, P₂O₇⁴⁻, (OCₙH₂ₙ₊₁)⁻, (CₙH₂ₙ₋₁O₂)⁻, (CₙH₂ₙ₋₃O₂)⁻, and (Cₙ₊₁H₂ₙ₋₂O₄)²⁻, where n stands for the numbers 1 to 20.

Preferred in this context are cesium carboxylates in which the anion conforms to the formulae (CₙH₂ₙ₋₁O₂)⁻ and also (Cₙ₊₁H₂ₙ₋₂O₄)²⁻ with n being 1 to 20. Particularly preferred cesium salts contain monocarboxylate anions of the general formula (CₙH₂ₙ₋₁O₂)⁻, where n stands for the numbers 1 to 20. Particularly deserving of mention in this context are formate, acetate, propionate, hexanoate, and 2-ethylhexanoate.

The reaction mixtures comprising polyisocyanates (A) thus obtained are generally used further as they are.

The reaction can be carried out optionally in an inert solvent or solvent mixture (E). After the reaction this solvent or solvent mixture is preferably not removed, but instead the polyisocyanate with solvent is used directly.

Preference is given to polar, nonprotic solvents such as esters, ethers, glycol ethers and glycol esters, preferably of propylene glycol, more preferably of ethylene glycol, and also carbonates.

Esters are, for example, n-butyl acetate, ethyl acetate, 1-methoxyprop-2-ylacetate, and 2-methoxyethyl acetate, gamma-butyrolactone, and also the monoacetyl and diacetyl esters of ethylene glycol, diethylene glycol, triethylene glycol, propylene glycol, dipropylene glycol or tripropylene glycol, examples being butylglycol acetate and butyldiglycol acetate.

Additionally conceivable are poly(C₂ to C₃)alkylene glycol (C₁ to C₄)monoalkyl ether acetates such as, for example, acetic esters of mono- or dipropylene glycol monomethyl ether.

Further examples are carbonates, preferably 1,2-ethylene carbonate, more preferably 1,2-propylene carbonate or 1,3-propylene carbonate.

Ethers are, for example, tetrahydrofuran (THF), dioxane, and the dimethyl, diethyl or di-n-butyl ethers of ethylene glycol, diethylene glycol, triethylene glycol, propylene glycol, dipropylene glycol or tripropylene glycol, preferably dipropylene glycol dimethyl ether, which is available as an isomer mixture under the trade name Proglyde® DMM from Dow Chemical Company, for example.

Particular preference is given to n-butyl acetate, 1-methoxyprop-2-yl acetate, 2-methoxyethyl acetate, N-methylpyrrolidone, gamma-butyrolactone, propylene carbonate (Solvenon® PC; 4-methyl-1,3-dioxolan-2-one), Butoxyl (3-methoxy-n-butyl acetate), butylglycol acetate, butyldiglycol acetate, dipropylene glycol dimethyl ether, propylene glycol diacetate, ethyl-3-ethoxypropionate, and also dicarboxylic esters and mixtures thereof, and also mixtures of the stated solvents.

Very particular preference is given to n-butyl acetate, 1,2-propylene carbonate, butylglycol acetate, butyldiglycol acetate, dipropylene glycol dimethyl ether, and 3-methoxy-n-butyl acetate.

A solvent (E) can also be added to the reaction mixture after the end of the reaction and prior to dispersion in the binder.

The mixture may further be admixed optionally with a further diisocyanate or, preferably, polyisocyanate (F), which can in principle be the same diisocyanates or polyisocyanates as set out above under (a), but which may also be different than said component (a).

Based on isocyanate groups, component (F) can be used in an amount from 0 to twenty times the amount of the polyisocyanate (A), preferably from 0 to ten times the amount.

The present invention further provides for the preparation of two-component polyurethane coating materials or aqueous dispersion-based adhesives. For this preparation the polyisocyanates (A) are mixed with an aqueous polyol component (D), preferably by being introduced into it. This is generally done with gentle to vigorous stirring, in order to disperse the polyisocyanates. It is an advantage of the polyisocyanates of the invention that they are readily dispersible in such aqueous solutions or dispersions of polyols as binders.

The dispersible polyisocyanates (A) of the invention may optionally further be blended with additional polyisocyanates that have not been modified for dispersibility, examples being those polyisocyanates as listed under (a), and, after blending, can be reacted with the binders. In this case care should be taken to note that the polyisocyanates (A) of the invention must be equipped with the actively dispersing components (b) and (c) in such a way that they are sufficiently dispersible in order to disperse the polyisocyanates in their entirety (polyisocyanate (A) and polyisocyanates which have not been modified for dispersibility).

The preparation of coating compositions from the water-emulsifiable polyisocyanates containing isocyanurate groups and prepared in accordance with the invention is accomplished by reaction with aqueous solutions, emulsions or dispersions of polyols: polyacrylate-ol, polyester-ol, polyurethane-ol, polyether-ol, and polycarbonate-ol dispersions, and also their hybrids and/or mixtures of the stated polyols. Hybrids means graft copolymers and other chemical reaction products which include chemically attached molecular moieties having different (or else like) groups from among those stated. Preference is given to polyacrylate-polyol dispersions, polyester-polyol dispersions, polyether-polyol dispersions, polyurethane-polyol dispersions, polycarbonate-polyol dispersions, and their hybrids.

Polyacrylate-ols can be prepared as primary or secondary dispersions, emulsions, and solutions. They are prepared from olefinically unsaturated monomers. These are, firstly, comonomers containing acid groups, having for example carboxylic, sulfonic acid and/or phosphonic acid groups or their salts, such as (meth)acrylic acid, vinylsulfonic acid or vinylphosphonic acid, for example. These are, secondly, comonomers containing hydroxyl groups, such as hydroxyalkyl esters or amides of (meth)acrylic acid, such as 2-hydroxyethyl and 2 or 3-hydroxypropyl(meth)acrylate, for example. These are, thirdly, unsaturated comonomers which contain neither acidic groups nor hydroxyl groups, such as alkyl esters of (meth)acrylic acid, styrene and derivatives, (meth)acrylonitrile, vinyl esters, vinyl halides, vinyl imidazole, etc. The properties can be influenced, for example, via the composition of the polymer, and/or, for example, via the glass transition temperatures of the comonomers (with different hardness).

Polyacrylate-ols for aqueous applications are described for example in EP 358979 (U.S. Pat. No. 5,075,370), EP 557844 (U.S. Pat. No. 6,376,602), EP 1141066 (U.S. Pat. No. 6,528,573) or 496210 (U.S. Pat. No. 5,304,400). One example of a commercially available secondary polyacrylate emulsion is Bayhydrol® A 145 (a product of Bayer MaterialScience). Examples of a primary polyacrylate emulsion are Bayhydrol® VP LS 2318 (a product of Bayer MaterialScience) and Luhydran® products from BASF AG.

Other examples are Macrynal® VSM 6299w/42WA from Cytec, and Setalux® AQ products from Nuplex Resins, such as Setalux® 6510 AQ-42, Setalux® 6511 AQ-47, Setalux® 6520 AQ-45, Setalux® 6801 AQ-24, Setalux® 6802 AQ-24, and Joncryl® from BASF Resins.

Polyacrylate-ols may also have a heterogeneous structure, as is the case for core-shell structures.

Polyester-ols for aqueous applications are described for example in EP 537568 (U.S. Pat. No. 5,344,873), EP 610450 (U.S. Pat. No. 6,319,981, polycondensation resin), and EP 751197 (U.S. Pat. No. 5,741,849, polyester-polyurethane mixture). Polyester-ols for aqueous applications are, for example, WorléePol products from Worlée-Chemie GmbH, Necowel® products from Ashland-Südchemie-Kernfest GmbH, and Setalux® 6306 SS-60 from Nuplex Resins.

Polyurethane-polyol dispersions for aqueous applications are described for example in EP 469389 (U.S. Pat. No. 559805). They are marketed, for example, under the brand name Daotan® from DSM NV.

Polyether-ols for aqueous applications are described for example in EP 758007.

Hybrids and mixtures of the various polyols are described for example in EP 424705 (U.S. Pat. No. 417998), EP 496205 (U.S. Pat. No. 5,387,642), EP 542085 (5308912, polyacrylate/polyether mixture), EP 542105 (U.S. Pat. No. 5,331,039), EP 543228 (U.S. Pat. No. 5,336,711, polyester/polyacrylate hybrids), EP 578940 (U.S. Pat. No. 5,349,041, polyester/urethane/carbonate), EP 758007 (U.S. Pat. No. 5,750,613, polyacrylate-polyether mixture), EP 751197 (U.S. Pat. No. 5,741,849), EP 1141065 (U.S. Pat. No. 6,590,028).

Polyesters/polyacrylates are described for example in EP 678536 (U.S. Pat. No. 5,654,391). One example of a secondary polyester/polyacrylate emulsion is Bayhydrol® VP LS 2139/2 (a product of Bayer MaterialScience).

To incorporate the water-emulsifiable polyisocyanates of the invention it is generally enough to distribute the inventively obtained polyisocyanate in the aqueous dispersion of the polyol. Generating the emulsion generally requires an energy input of 0 to not more than 10⁸ W/m³.

The dispersions generally have a solids content of 10% to 85%, preferably of 20% to 70% by weight and a viscosity of 10 to 500 mPa*s.

For the preparation of a coating composition, polyisocyanate (A) and also, optionally, (F) and binders are mixed with one another in a molar ratio of isocyanate groups to isocyanate-reactive groups of 0.1:1 to 10:1, preferably 0.2:1 to 5:1, more preferably 0.3:1 to 3:1, and very preferably 0.5:1 to 2.5:1, it also being possible, if appropriate, for further, typical coatings constituents to be mixed in, and the final composition is applied to the substrate.

In one embodiment of the invention, when using a primary (polyacrylate) dispersion, the ratio of NCO to NCO-reactive groups is from 1:8 to 2:1, preferably from 1:2 to 1:3, and more preferably about 1:2.5.

In another embodiment of the invention, when using a secondary (polyacrylate) dispersion, the ratio of NCO to NCO-reactive groups is from 1.3:1 to 2:1, more particularly from 1.4:1 to 1.8:1.

Curing typically takes place until the cured materials can be handled further. The properties associated with this are, for example, dust drying, through-drying, blocking resistance or packability.

In one preferred embodiment the curing takes place at room temperature within not more than 12 hours, preferably up to 8 hours, more preferably up to 6 hours, very preferably up to 4 hours, and more particularly up to 3 hours.

In another preferred version the curing takes place, for example, for half an hour at temperatures up to 80° C. After cooling, a room-temperature postcure may be necessary in addition.

The coating of the substrates takes place in accordance with typical methods known to the skilled worker, which involve applying at least one coating composition in the desired thickness to the substrate that is to be coated, and removing any volatile constituents that may be present in the coating composition, if appropriate with heating. This operation can if desired be repeated one or more times. Application to the substrate may take place in a known way, as for example by spraying, troweling, knifecoating, brushing, rolling, roller coating, pouring, laminating, injection backmolding or coextruding.

The thickness of a film of this kind to be cured can be from 0.1 μm up to several mm, preferably from 1 to 2000 μm, more preferably 5 to 200 μm, very preferably from 10 to 60 μm (based on the coating material in the state in which the solvent has been removed from the coating material).

Also provided by the present invention are substrates coated with a multicoat paint system of the invention.

Polyurethane coating materials of this kind are especially suitable for applications requiring a particularly high level of application reliability, external weathering resistance, optical qualities, solvent resistance, chemical resistance, and water resistance.

The resulting coating compositions and coating formulations are suitable for coating substrates such as wood, wood veneer, paper, paperboard, cardboard, textile, film, leather, nonwoven, plastics surfaces, glass, ceramic, mineral building materials, such as cement moldings, fiber-cement slabs or metals, each of which may optionally have been precoated and/or pretreated, more particularly for plastics surfaces.

Coating compositions of this kind are suitable as or in interior or exterior coatings, i.e., applications of this kind involving exposure to daylight, preferably of parts of buildings, coatings on (large) vehicles and aircraft, and industrial applications, decorative coatings, bridges, buildings, power masts, tanks, containers, pipelines, power stations, chemical plants, ships, cranes, posts, sheet piling, valves, pipes, fittings, flanges, couplings, halls, roofs, and structural steel, furniture, windows, doors, woodblock flooring, can coating and coil coating, for floor coverings, as in the case of parking levels, or in hospitals, and in automobile finishes as OEM and refinish application.

Coating compositions of this kind are preferably used at temperatures between ambient temperature to 80° C., preferably to 60° C., more preferably to 40° C. The articles in question here are preferably those which cannot be cured at high temperatures, such as large machines, aircraft, large-volume vehicles, and refinish applications.

The coating compositions of the invention are employed more particularly as clearcoat, basecoat, and topcoat materials, primers, and surfacers.

Polyisocyanate compositions of this kind can be used as curing agents for producing coating materials, adhesives, and sealants.

Likewise provided by the present invention, accordingly, are coating materials, adhesives, and sealants comprising at least one polyisocyanate composition of the invention, and also substrates which are coated, bonded or sealed using them.

Figures in ppm or percent that are used in this specification relate, unless otherwise indicated, to weight percentages and ppm by weight.

The examples which follow are intended to illustrate the invention but not to confine it to these examples.

### EXAMPLES

### Polyisocyanate PI 1

Polyisocyanate prepared by trimerizing some of the isocyanate groups of 1,6-diisocyanatohexane (HDI) and containing isocyanurate groups, said polyisocyanate being composed substantially of tris(6-isocyanatohexyl) isocyanurate and its higher homologs, with an NCO content of 22.2%, a monomeric diisocyanate content of less than 0.3%, a viscosity at 23° C. of 1900 mPa*s, and an average NCO functionality of approximately 3.3.

### Polyisocyanate PI 2

Low-viscosity polyisocyanate prepared by trimerizing some of the isocyanate groups of 1,6-diisocyanatohexane (HDI) and containing isocyanurate groups, said low-viscosity polyisocyanate being composed substantially of tris(6-isocyanatohexyl)isocyanurate and its higher homologs, with an NCO content of 23.5%, a monomeric diisocyanate content of less than 0.3%, a viscosity at 23° C. of 1330 mPa*s, and an average NCO functionality of approximately 3.45. This product is available under the trade name Basonat® LR 9046 from BASF Aktiengesellschaft, Ludwigshafen, Germany.

### Polyisocyanate PI 3

Polyisocyanate prepared by trimerizing some of the isocyanate groups of 1-isocyanato-3,3,5-trimethyl-5-(isocyanatomethyl)cyclohexane (isophorone diisocyanate; IPDI) and containing isocyanurate groups, said polyisocyanate being composed substantially of tris(6-isocyanatohexyl)isocyanurate and its higher homologs, with an NCO content of 12.0% by weight, a monomeric diisocyanate content of less than 0.5% by weight, a viscosity at 23° C. of 600 mPa*s, and an average NCO functionality of approximately 3.0. This product is available under the trade name Basonat IT 170 B from BASF Aktiengesellschaft, Ludwigshafen, Germany.

### Polyisocyanate PI 4

Polyisocyanate prepared by allophanatizing some of the isocyanate groups of 1,6-diisocyanatohexane (HDI) and containing allophanate groups, said polyisocyanate with an NCO content of 22.0% by weight, a monomeric diisocyanate content of less than 0.3%, a viscosity at 23° C. of 1100 mPa*s, and an average NCO functionality of approximately 4.9. This product is available under the trade name Basonat HA 100 from BASF Aktiengesellschaft, Ludwigshafen, Germany.

### Polyisocyanate PI 5

Polyisocyanate prepared by allophanatizing some of the isocyanate groups of 1,6-diisocyanatohaxane (HDI) and containing allophanate groups, said polyisocyanate with an NCO content of 19.5%, a monomeric diisocyanate content of less than 0.3%, a viscosity at 23° C. of 350 mPa*s, and an average NCO functionality of approximately 2.8. This product is available under the trade name Basonat HA 300 from BASF Aktiengesellschaft, Ludwigshafen, Germany.

### Polyetherols

### Polyetherol PEO 1

Monofunctional polyethylene oxide prepared starting from methanol and with potassium hydroxide catalysis, with an average OH number of 112 mg KOH/g, measured to DIN 53 240, corresponding to a molecular weight of 500 g/mol. The residues of catalyst still present were subsequently neutralized with acetic acid. The basicity was determined by titration with HCl to be 10.6 mmol/kg.

### Polyetherol PEO 2

Monofunctional polyethylene oxide prepared starting from methanol and with potassium hydroxide catalysis, with an average OH number of 112 mg KOH/g, measured to DIN 53 240, corresponding to a molecular weight of 500 g/mol. The residues of catalyst still present were subsequently neutralized with acetic acid and the product was desalinated. In the course of this procedure, potassium acetate formed was also removed.

### Example 1

250 g of polyisocyanate PI 1 were admixed with 6.25 g (33.4 mmol) of 4-aminotoluene-2-sulfonic acid and 4.25 g (33.4 mmol) of dimethylcyclohexylamine, and also with 20 g of polyetherol PEO 1, and the mixture was stirred at 100° C. for 30 minutes. The reaction was halted by addition of 0.15 g of para-toluenesulfonic acid. The very readily water-dispersible product had an NCO content of 18.1%, a viscosity of 5370 mPa*s at 23° C., and a sulfonate group content of 122 mmol/kg.

| | |
|---|---|
| Solids content | 100% |
| NCO content | 18.1% |
| NCO functionality | 3.0 |
| Viscosity (23° C.) | 5370 mPa*s |
| Sulfonate group content | 122 mmol/kg |
| | (corresponding to 1.0% by weight) |
| Incorporated alkylene | 6.7% |
| oxide group content | |

### Example 2

250 g of polyisocyanate PI 1 were admixed with 3.13 g (16.7 mmol) of 4-aminotoluene-2-sulfonic acid and 2.13 g (16.7 mmol) of dimethylcyclohexylamine, and also with 10 g of polyetherol PEO 1, and the mixture was stirred at 100° C. for 1 hour. The reaction was halted by addition of 0.15 g of para-toluenesulfonic acid. The very readily water-dispersible product had an NCO content of 19.95%, a viscosity of 4250 mPa*s at 23° C., and a sulfonate group content of 66 mmol/kg.

| | |
|---|---|
| Solids content | 100% |
| NCO content | 19.95% |
| NCO functionality | 2.9 |
| Viscosity (23° C.) | 4250 mPa*s |
| Sulfonate group content | 66 mmol/kg |
| | (corresponding to 0.53% by weight) |
| Incorporated alkylene | 3.5% |
| oxide group content | |

### Example 3

250 g of polyisocyanate PI 1 were admixed with 4.7 g (25.1 mmol) of 4-aminotoluene-2-sulfonic acid and 3.19 g (25.1 mmol) of dimethylcyclohexylamine, and also with 5 g of polyetherol PEO 1, and the mixture was stirred at 100° C. for 1 hour. The reaction was halted by addition of 0.05 g of para-toluenesulfonic acid. The readily water-dispersible product had an NCO content of 20.2%, a viscosity of 6630 mPa*s at 23° C., and a sulfonate group content of 96 mmol/kg.

| | |
|---|---|
| Solids content | 100% |
| NCO content | 20.2% |
| NCO functionality | 3.1 |
| Viscosity (23° C.) | 6630 mPa*s |
| Sulfonate group content | 96 mmol/kg |
| | (corresponding to 0.78% by weight) |
| Incorporated alkylene | 1.8% |
| oxide group content | |

### Example 4

250 g of polyisocyanate PI 2 were admixed with 3.13 g (16.7 mmol) of 4-aminotoluene-2-sulfonic acid and 2.13 g (16.7 mmol) of dimethylcyclohexylamine, and also with 10 g of polyetherol PEO 1, and the mixture was stirred at 100° C. for 30 minutes. The reaction was halted by addition of 0.15 g of para-toluenesulfonic acid. The very readily water-dispersible product had an NCO content of 20.3%, a viscosity of 3962 mPa*s at 23° C., and a sulfonate group content of 66 mmol/kg.

| | |
|---|---|
| Solids content | 100% |
| NCO content | 20.3% |
| NCO functionality | 3.0 |
| Viscosity (23° C.) | 3962 mPa*s |
| Sulfonate group content | 66 mmol/kg |
| | (corresponding to 0.53% by weight) |
| Incorporated alkylene | 3.5% |
| oxide group content | |

### Example 5

250 g of polyisocyanate PI 4 were admixed with 3.13 g (16.7 mmol) of 4-aminotoluene-2-sulfonic acid and 2.13 g (16.7 mmol) of dimethylcyclohexylamine, and also with 10 g of polyetherol PEO 1, and the mixture was stirred at 100° C. for 30 minutes. The reaction was halted by addition of 0.15 g of para-toluenesulfonic acid. The very readily water-dispersible product had an NCO content of 20.3%, a viscosity of 1977 mPa*s at 23° C., and a sulfonate group content of 66 mmol/kg.

| | |
|---|---|
| Solids content | 100% |
| NCO content | 20.3% |
| NCO functionality | 2.9 |
| Viscosity (23° C.) | 1977 mPa*s |
| Sulfonate group content | 66 mmol/kg |
| | (corresponding to 0.53% by weight) |
| Incorporated alkylene | 3.5% |
| oxide group content | |

### Example 6

250 g of polyisocyanate PI 5 were admixed with 3.13 g (16.7 mmol) of 4-aminotoluene-2-sulfonic acid and 2.13 g (16.7 mmol) of dimethylcyclohexylamine, and also with 10 g of polyetherol PEO 1, and the mixture was stirred at 100° C. for 30 minutes. The reaction was halted by addition of 0.15 g of para-toluenesulfonic acid. The very readily water-dispersible product had an NCO content of 16.7%, a viscosity of 933 mPa*s at 23° C., and a sulfonate group content of 66 mmol/kg.

| | |
|---|---|
| Solids content | 100% |
| NCO content | 16.7% |
| NCO functionality | 2.3 |
| Viscosity (23° C.) | 933 mPa*s |
| Sulfonate group content | 66 mmol/kg |
| | (corresponding to 0.53% by weight) |
| Incorporated alkylene | 3.5% |
| oxide group content | |

### Example 7

250 g of polyisocyanate PI 1 were admixed with 10 g of polyetherol PEO 2 and the mixture was stirred at 100° C. for 30 minutes, and then 3.13 g (16.7 mmol) of 4-aminotoluene-2-sulfonic acid and 2.13 g (16.7 mmol) of dimethylcyclohexylamine were added and the mixture was reacted at 80° C. for a further 30 minutes. The very readily water-dispersible product has an NCO content of 20.15%, a viscosity of 3450 mPa*s at 23° C., and a sulfonate group content of 63 mmol/kg.

| | |
|---|---|
| Solids content | 100% |
| NCO content | 20.15 |
| NCO functionality | 3.0 |
| Viscosity (23° C.) | 3450 mPa*s |
| Sulfonate group content | 63 mmol/kg |
| | (corresponding to 0.47% by weight) |
| Incorporated alkylene | 3.5% |
| oxide group content | |

### Example 8

142.9 g of polyisocyanate PI 1 and 153 g of polyisocyanate PI 3 were admixed with 10 g of polyetherol PEO 2 and the mixture was reacted at 100° C. for 1 hour. Then 3.13 g (16.7 mmol) of 4-aminotoluene-2-sulfonic acid and 2.13 g (16.7 mmol) of dimethylcyclohexylamine were added and the mixture was reacted at 80° C. for a further hour. The very readily water-dispersible product has an NCO content of 16.5%, a viscosity of 8707 mPa*s at 23° C., and a sulfonate group content of 91 mmol/kg.

| | |
|---|---|
| Solids content | 85% |
| NCO content | 16.5% |
| NCO functionality | 3.0 |
| Viscosity (23° C.) | 8707 mPa*s |
| Sulfonate group content | 91 mmol/kg |
| | (corresponding to 0.43% by weight) |
| Incorporated alkylene | 3.0% |
| oxide group content | |

### Example 9

### Comparative

250 g of polyisocyanate PI 1 were admixed with 12.5 g (72.2 mmol) of 4-aminobenzenesulfonic acid (sulfanilic acid) and 9.17 g (72.2 mmol) of dimethylcyclohexylamine and the mixture was stirred first at 80° C. for 5 hours and then at 100° C. for 1 hour. The sulfanilic acid did not dissolve.

### Example 10

### Comparative

250 g of polyisocyanate PI 1 were admixed with 12.5 g (72.6 mmol) of 3-aminobenzenesulfonic acid (metanilic acid) and 9.17 g (72.2 mmol) of dimethylcyclohexylamine and the mixture was stirred first at 80° C. for 5 hours and then at 100° C. for 1 hour. The metanilic acid did not dissolve.

### Example 11

### Comparative

250 g of polyisocyanate PI 1 were admixed with 12.5 g (66.8 mmol) of 2-aminotoluene-5-sulfonic acid and 8.5 g (66.8 mmol) of dimethylcyclohexylamine and the mixture was stirred first at 100° C. for 3 hours. The 2-aminotoluene-5-sulfonic acid did not dissolve.

### Example 12

### Comparative

250 g of polyisocyanate PI 1 were admixed with 12.5 g (66.8 mmol) of 5-aminotoluene-2-sulfonic acid and 8.5 g (66.8 mmol) of dimethylcyclohexylamine and the mixture was stirred first at 100° C. for 3 hours. The 5-aminotoluene-2-sulfonic acid dissolved, but the product was not readily water-dispersible.

### Example 13

### Comparative

250 g of polyisocyanate PI 1 were admixed with 12.5 g (49.5 mmol) of 3-(4-(2-hydroxy-ethyl)-1-piperazinyl)propanesulfonic acid (HEPPS) and 6.3 g (49.5 mmol) of dimethylcyclohexylamine and the mixture was stirred first at 100° C. for 4 hours. HEPPS did not dissolve.

### Example 14

### Comparative, in Analogy to Example 1, DE 199 58 170

500 g of polyisocyanate PI 1 were admixed at 100° C. over the course of 30 minutes with 88 g of polyetherol PEO 2 and the mixture was stirred at this temperature for approximately 2 hours until the theoretical NCO value of 17.6% was reached. Then allophanatization was carried out by addition of 0.01 g of zinc(II) ethylhexanoate and, when an NCO value of 16.2% was reached, the reaction was halted by addition of 0.01 g of benzoyl chloride. The resulting isocyanate had a viscosity of 6800 mPa*s.

### Example 15

### Comparative, in Analogy to Example 3, EP 1 287 052

500 g of polyisocyanate PI 1 were admixed with 15.4 g (0.07 mol) of 3-(cyclohexylamino)propanesulfonic acid and 9.0 g (0.07 mol) of dimethylcyclohexylamine. The mixture was reacted at 80° C. for 2 hours, to give a water-dispersible polyisocyanate with an NCO content of 20.5% and a viscosity of 6000 mPa*s.

### Example 16

### Comparative

Basonat® HW 100 from BASF AG, Ludwigshafen, having an NCO content of 17% and a viscosity (23° C.) of 4000 mPa*s.

### Example 17

### Comparative

Rhodocoat® WT 2102 from Rhodia, having an NCO content of 18.76%.

### Application Example A

Use as crosslinker in aqueous 2-component (2K) polyurethane systems (incorporation by hand)

Hydroxy-functional component A (Polyol A):

100 parts of an approximately 45%, aqueous dispersion of the hydroxy-functional polyacrylate resin Luhydran® S 937 T from BASF AG, Ludwigshafen, with an average OH number of 100 mg KOH/g (based on solids), were admixed with 2.4 parts of butyldiglycol acetate, 6.5 parts of butylglycol acetate, 6.4 parts of fully demineralized water, 1.46 parts of dimethylethylamine (1:1 in water), 3.75 parts of fully demineralized water, 0.38 part of the defoamer Agitan® 299 from Münzing Chemie GmbH, Heilbronn, and 0.63 part of the wetting and flow agent Fluorad® FC 4430, 10% in water, from 3M. The hydroxy-functional component is homogenized with stirring using a Dispermat. The pH of the solution, prior to use, should be situated within the recommended pH range of 8.0-8.5.

### Isocyanate-Functional Components:

Unless described otherwise in table 1, the isocyanates from the above examples were diluted to a solids content of 80% with dipropylene glycol dimethyl ether (Proglyde® DMM from DOW).

The emulsification of the polyol A, of the polyisocyanate, and of a further quantity of water (see table 1) was carried out by hand as follows: the hydroxy-functional component was placed in a 100 ml glass vessel and the polyisocyanate component was added. After 30 seconds, the mixture was stirred by hand, using a wooden spatula, for about 30 seconds. The amount of water needed to make up the total coating material to a solids content of 37% was added, and stirring was continued for 20 seconds. Thereafter the mixture was left to stand for 10 minutes for degassing to take place. The proportions of the components are reported in table 1.

TABLE 1
use of the polyisocyanates in aqueous 2K PU coating
materials. Proportions of the components

| | Example with polyisocyanate from example | | | | |
|---|---|---|---|---|---|
| | | | | 14 | 16 |
| | 2 | 4 | 5 | (Comparative) | (Comparative) |
| Polyol A [g] | 70 | 70 | 70 | 70 | 70 |
| Polyisocyanate | 4.8 | 4.6 | 4.4 | 6.0 | 5.7 |
| [g] | | | | | |
| Water [g] | 2.4 | 12.0 | 13 | 3.7 | 3.4 |
| Nonvolatile | 38.5 | 34.3 | 34.0 | 38.5 | 38.5 |
| fraction | | | | | |

Thereafter the films were applied with a film-drawing frame (box-type coating bar) in a wet film thickness of 150 μm.

The investigations took place in a climatically conditioned room at 50±10% atmospheric humidity and 23±2° C. The tests carried out were as follows:

Film impression on a glass plate.

König pendulum hardness to DIN 53157, in number of swings (glass plate).

Gloss (Bonder panel).

Sand application test: with the sand application test (glass plate; duplicate determination) the through-drying is ascertained.

For the measurement of the through-drying, two small wheels run over the coating. These wheels have a diameter of 19-29 mm and a width of 3 mm. The placement of a hopper (107-117 g inherent weight plus 60-80 g of sand) onto the wheels and hence onto the wet coating film produces a broad furrow in the coating film. Measurement begins in the middle of this furrow. Immediately after drawdown, the coating is drawn along beneath the wheels at a speed of 1 cm/h. The coating film has dried through when a distinct track is no longer apparent or when the track is interrupted for several centimeters.

Films were obtained which had the following properties:

| | Polyisocyanate from example | | | | |
|---|---|---|---|---|---|
| | | | | 14 | 16 |
| | 2 | 4 | 5 | (Comparative) | (Comparative) |
| Sediment in beaker | Trace | Trace | Trace | Very great | Great |
| Optical qualities | Homogeneous | Homogeneous | Homogeneous | Copious | Some coagulum, |
| of wet film | film, good | film, good | film, good | coagulum, | isolated |
| | leveling | leveling | leveling | fish eyes | streaks |
| Gloss | 96 | 90 | 95 | Not | 93 |
| (30 min, 60° C., 24 h RT), | | | | measurable | |
| 60° [%] | | | | | |
| Gloss | 53 | 56 | 66 | Not | 52 |
| (30 min, 60° C., 24 h RT), | | | | measurable | |
| 20° [%] | | | | | |

Pendulum hardness (swings)

| | | | | | |
|---|---|---|---|---|---|
| 1 d, RT | 80 | 85 | 97 | 67 | 80 |
| 7 d, RT | 119 | | | 110 | 119 |
| 30 min 110° C., 24 h RT | 153 | | | 147 | 147 |
| Through-drying | 3.5 h | 3 h | 2.75 h | 4.5 h | 5.0 h |

The gloss is measured at the stated angle after drying at the stated temperature for the stated time.

The pendulum hardness is measured after drying at the stated temperature (RT=room temperature) for the stated time (d=day).

The comparisons show that the inventive polyisocyanates are easy to incorporate by hand into the hydroxy-functional component, but at the same time give coating materials which dry effectively.

### Application Example B

Use as crosslinker in aqueous two-component (2K) polyurethane coating materials (with stirred incorporation with high shearing energy)

### Hydroxy-Functional Component B (Polyol B):

100 parts of an approximately 42%, aqueous dispersion of the hydroxy-functional polyacrylate resin Macrynal® VSM 6299w/42 WA from Cytec, with an average OH number of 135 mg KOH/g (based on solids), were admixed with 2.09 parts of Surfynol® 104 (about 50% in butylglycol, from Biesterfeld) and stirred at 1800 rpm for 15 minutes. 0.38 part of Additol® XW 390 from Vianova Resins was added and stirring was continued at 1800 rpm for 5 minutes. 14.48 parts of fully demineralized water were added and the mixture was stirred.

### Isocyanate-Functional Components:

The isocyanates from the above examples were diluted to a solids content of 80% with Butoxyl® (3-methoxy-n-butyl acetate from Biesterfeld).

Emulsification took place with a Dispermat at 2000 rpm for 5 minutes. The hydroxy-functional component was introduced and then the polyisocyanate component was added. After 30 seconds, stirring was carried out by hand, using a wooden spatula, for about 30 seconds. The amount of water needed to make up the total coating material to a solids content of 37% was added, and stirring was continued for 20 seconds. Thereafter the mixture was left to stand for 10 minutes for degassing. The proportions of the components are reported in table 2.

TABLE 2
Use of the polyisocyanates in aqueous 2K PU
coating materials (approximately 34% concentration).
Proportions of the components

| Polyisocyanate from example | 2 | 16 | 17 |
|---|---|---|---|
| Polyol B [g] | 70 | 70 | 70 |
| Polyisocyanate [g] | 32.4 | 27.8 | 29.5 |
| Water [g] | 25.3 | 20.7 | 22.6 |

Thereafter the films were applied using a film-drawing frame (box-type coating bar) in a wet film thickness of 150 μm.

Films were obtained which had the following properties:

| | Polyisocyanate from | | |
|---|---|---|---|
| | | Comparative | Comparative |
| | Example 2 | example 16 | example 17 |
| Appearance | Clear, | Clear, | Clear, |
| | colorless | colorless | colorless |
| Gloss | 95 | 95 | 95 |
| (30 min, 60° C., 24 h RT), | | | |
| 60° [%] | | | |
| Gloss | 80 | 85 | 83 |
| (30 min, 60° C., 24 h RT), | | | |
| 20° [%] | | | |
| Pendulum hardness | | | |
| (swings) | | | |
| 6 h, RT | 12 | 6 | 6 |
| 1 d, RT | 85 | 52 | 75 |
| 7 d, RT | 93 | 67 | 83 |
| 30 min 60° C., 24 h RT | 123 | 79 | 111 |
| 30 min 110° C., 24 h RT | 137 | 124 | 137 |
| Through-drying | 6.5 h | 8 h | 4.5 h |

The comparison shows that the inventive polyisocyanates give a well-drying coating material even with relatively high shearing energies.

### Application Example C

Use as crosslinker in aqueous two-component (2K) polyurethane systems (incorporation by Dispermat)

The experiments took place in the same way as for application example A, with the hydroxy-functional component A (polyol A). The polyisocyanate components in 100% form were diluted to 80% with Proglyde® DMM. Polyisocyanate and water were each incorporated by stirring with a Dispermat, so that the components dissolved homogeneously and the formation of microfoam was kept at a low level.

Use of the polyisocyanates in aqueous 2K PU coating materials. Proportions of the components

| Example with polyisocyanate from example | 2 | 15 (Comparative) |
|---|---|---|
| Polyol A [g] | 70 | 70 |
| Polyisocyanate [g] | 4.8 | 4.7 |
| Water [g] | 2.4 | 2.4 |
| Nonvolatile fraction | 38.5 | 38.5 |

The investigations took place as for application example A. Films were obtained which had the following properties:

| Polyisocyanate from example | 2 | 15 (Comparative) |
|---|---|---|
| Gloss (30 min, 60° C., 24 h RT), 60° [%] | 85 | 60 |
| Gloss (30 min, 60° C., 24 h RT), 20° [%] | 42 | 21 |
| 30 min 60° C., 24 h RT | 128 | 114 |
| 30 min 110° C., 24 h RT | 150 | 147 |
| Through-drying | 3.5 h | 5.0 h |

The comparisons show that the inventive polyisocyanate, when incorporated by stirring with the Dispermat, exhibits advantages over comparative example 15 in terms of through-drying at room temperature, and also after 30 minutes' curing at 60° C. and subsequent postcure for 24 h at room temperature, in the pendulum hardness and in the gloss, and also through a shortened through-drying time.

1. A water-dispersible polyisocyanate (A), comprising as synthesis components
(a) at least one diisocyanate or polyisocyanate,
(b) at least one substituted aromatic sulfonic acid which carries precisely one primary or secondary amino group, the positions on the aromatic ring ortho to the amino group being unsubstituted,
(c) at least one monofunctional polyalkylene glycol,
(d) optionally at least one high molecular mass diol or polyol, and
(e) optionally at least one low molecular mass diol or polyol.

2. The water-dispersible polyisocyanate (A) according to claim 1, wherein component (a) is a polyisocyanate synthesized from (cyclo)aliphatic isocyanates.

3. The water-dispersible polyisocyanate (A) according to claim 1, wherein component (a) is a polyisocyanate containing allophanate and/or isocyanurate groups which is based on isophorone diisocyanate and/or 1,6-hexamethylene diisocyanate.

4. The water-dispersible polyisocyanate (A) according to claim 1, wherein component (b) is a substituted aromatic sulfonic acid of the formula (I) 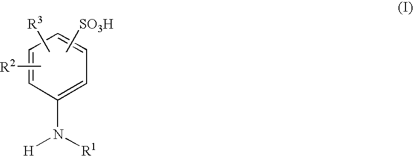
in which
R¹, R² and R³ independently of one another are hydrogen, alkyl, cycloalkyl or aryl, wherein each of the stated radicals may be substituted by aryl, alkyl, aryloxy, alkyloxy, heteroatoms and/or heterocycles,
and R² and R³ may also together form a ring,
with the proviso that at least one of the radicals R² and R³ is other than hydrogen.

5. The water-dispersible polyisocyanate (A) according to claim 4, wherein one of the radicals R² and R³ in formula (I) is hydrogen and the other is other than hydrogen.

6. The water-dispersible polyisocyanate (A) according to claim 4, wherein the sulfonic acid group in formula (I) is located meta to the primary or secondary amino group on the aromatic ring.

7. The water-dispersible polyisocyanate (A) according to claim 5, wherein, of the substituents R² and R³ in formula (I), the one which is other than hydrogen is located para on the aromatic ring relative to the primary or secondary amino group.

8. The water-dispersible polyisocyanate (A) according to claim 1, wherein the compound (b) is selected from the group consisting of 4-aminotoluene-2-sulfonic acid, 5-aminotoluene-2-sulfonic acid, and 2-aminonaphthalene-4-sulfonic acid.

9. The water-dispersible polyisocyanate (A) according to claim 1, wherein the compound (c) fulfills the formula
R⁴—O—[—Xᵢ—]ₖ—H
in which
R⁴ is C₁-C₂₀ alkyl, C₂-C₂₀ alkyl uninterrupted or interrupted by one or more oxygen and/or sulfur atoms and/or by one or more substituted or unsubstituted imino groups, or is C₆-C₁₂ aryl, C₅-C₁₂ cycloalkyl or a five- or six-membered heterocycle containing oxygen, nitrogen and/or sulfur atoms, it being possible for each of the stated radicals to be substituted by functional groups, aryl, alkyl, aryloxy, alkyloxy, halogen, heteroatoms and/or heterocycles,
k is an integer from 5 to 40, and
each Xᵢ for i=1 to k can be selected independently from the group consisting of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, and —CHPh-CH₂—O—,
in which Ph is phenyl and Vin is vinyl.

10. The water-dispersible polyisocyanate (A) according to claim 1, having the following construction, based on isocyanate groups in synthesis component (a):
(b) 0.5 to 30 mol % of primary or secondary amino groups,
(c) at least 0.3 mol % up to 25 mol %, based on isocyanate-reactive groups in (c),
(d) 0 to 15 mol %, based on isocyanate-reactive groups in (d), and
(e) 0 to 15 mol %, based on isocyanate-reactive groups in (e).

11. The water-dispersible polyisocyanate (A) according to claim 1, wherein the sulfonic acid groups have been at least partly neutralized.

12. The water-dispersible polyisocyanate (A) according to claim 11, wherein the sulfonic acid groups have been at least partly neutralized with tertiary amines.

13. An aqueous coating composition comprising at least one water-dispersible polyisocyanate (A) according to claim 1 and at least one binder selected from the group consisting of polyacrylate-polyol dispersions, polyester-polyol dispersions, polyether-polyol dispersions, polyurethane-polyol dispersions, polycarbonate-polyol dispersions, and their hybrids.

14. A composition for coating wood, wood veneer, paper, paperboard, cardboard, textile, film, leather, nonwoven, plastics surfaces, glass, ceramic, mineral building materials, cement moldings, fiber-cement slabs or metals, each of which may optionally have been precoated or pretreated comprising at least one water-dispersible polyisocyanate (A) according to claim 1.

15. A composition for coating parts of buildings, (large) vehicles, aircraft, industrial applications, decorative coatings, bridges, buildings, power masts, tanks, containers, pipelines, power stations, chemical plants, ships, cranes, posts, sheet piling, valves, pipes, fittings, flanges, couplings, halls, roofs, and structural steel, furniture, windows, doors, woodblock flooring, can coating and coil coating, for floor coverings, parking levels, in hospitals, and in automobile finishes as OEM and refinish application comprising at least one water-dispersible polyisocyanate (A) according to claim 1.

16. A coating material, adhesive or sealant comprising at least one polyisocyanate according to claim 1.

17. A substrate coated, bonded or sealed with a coating material, adhesive or sealant according to claim 16.
